(19) United States
(12) Patent Application Publication
(10) Pub. No.: US 2026/0322185 A1
(43) Pub. Date: Oct. 15, 2026

(54) An over molded, high-performance motor and actuator rotor with product and process improvements necessary to meet the tight dimensional requirements that are necessary to maintain a critical magnetic air gap when utilized with high energy magnets affixed to the perimeter of the rotor.

(71) Applicants: Timothy J Trueblood, Pendleton, IN (US); Mitchell L Spencer, Carmel, IN (US); Trent Powell, Milwaukee, WI (US); Zhang Pei He, Ningbo (CN); Xu Feng, Ningbo (CN)

(72) Inventors: Timothy J Trueblood, Pendleton, IN (US); Mitchell L Spencer, Carmel, IN (US); Trent Powell, Milwaukee, WI (US); Zhang Pei He, Ningbo (CN); Xu Feng, Ningbo (CN)

(21) Appl. No.: 19/302,049

(22) Filed: Aug. 17, 2025

Related U.S. Application Data
(60) Provisional application No. 63/684,357, filed on Aug. 17, 2024.

(51) Int. Cl. H02K 1/02; H02K 1/27; H02K 7/00; H02K 15/021; H02K 15/035; H02K 15/70

(52) U.S. Cl. CPC H02K 1/02; H02K 1/27; H02K 7/003; H02K 15/021; H02K 15/035; H02K 15/70

(57) ABSTRACT

An over molded, high-performance motor and actuator rotor with product and process improvements necessary to meet the tight dimensional requirements that are necessary to maintain a critical magnetic air gap when utilized with high energy magnets affixed to the perimeter of the rotor. The most critical property regarding motor performance is the airgap between a rotor and stator. This device maintains a repeatable airgap of approximately 1.0 MM or less. The significant forces on the rotating magnets require a rough and clean surface preparation (without oxidation) of the Powdered Metals (PM) to accept the magnets on the cores in the magnetic circuit of a rotor. The PM core surfaces require a preparation to clean and roughen the surfaces of a recessed gap/recess/reservoir 53 to affix/glue 72 the magnets to the PM Core.

### CROSS REFERENCE TO RELATED APPLICATIONS

This application claims the benefit of United States Provisional Patent Application with Ser. No. 63/684,357 filed Aug. 17, 2024, by Timothy J. Trueblood, et al. The provisional application is entitled “An over molded, high-performance motor and actuator rotor with product and process improvements necessary to meet the tight dimensional requirements that are necessary to maintain a critical magnetic air gap when utilized with high energy magnets affixed to the perimeter of the rotor.”

### FIELD OF INVENTION

This invention relates to an over molded, high-performance motor and actuator rotor with product and process improvements necessary to maintain a critical magnetic air gap when utilized with high energy magnets affixed to the perimeter of the rotor.

### FEDERALLY SPONSORED RESEARCH

None.

### SEQUENCE LISTING OR PROGRAM

None.

### BACKGROUND-FIELD OF INVENTION and PRIOR ART

As far as known, there are no other over molded, high-performance motor and actuator rotor with product and process improvements necessary to maintain a critical magnetic air gap when utilized with high energy magnets affixed to the perimeter of the rotor.

This high energy rotor requires a combination of processing measures that were developed in order to meet the difficult mechanical requirements of a motor or actuator rotor which has high energy magnets affixed to the perimeter of the rotor. The airgap between a rotor and stator is the most critical property with regard to motor performance. The goal is to maintain a repeatable airgap between the rotor and stator of approximately 1.0 MM or less. To successfully produce production volumes of these rotors, several problems were addressed and rectified. These processes are required as a combination of these three (3) critical and unusual process or design considerations.

### Problems Addressed

The forces on the rotating magnets are significant, and the surface preparations of the core for such applications have been found to require more than normal surface preparation. Powdered Metals (PM) or other soft magnetic metals are commonly used as the materials to make cores in the magnetic circuit of a rotor. Even the thinnest layer of oxidation, or contamination from handling, or contamination from the atmosphere, are all known to produce a surface layer which becomes a barrier to both adhesive strength and to magnetic flux permeability. The solution for this was to sandblast (or equal) the surfaces. See Operation Section, below.

An inconsistent application of the adhesive between the magnet and the PM core will contribute to unacceptable variation in the outer profile of the rotor and correspondingly cause severe variation in the airgap of the assembled system. The solution was to design and create a rectangular volume or “well” or “reservoir” on each surface of the PM core in the area where the magnets will be affixed. See Operation Section, below. The configuration of the shaft and core can impact the dimensional integrity and angular relationship of the mounting shaft and the rotor core. The press fit can only hold so much resistance for radial and axial movement between the shaft and the core. The integrity of the shaft and core was much improved by featuring a straight/or parallel to the axis knurl. This in turn allowed the gap between the rotor and the stator to have a smaller variation and provided repeatable results. In addition, the knurl increased the rotational resistance and maintained the angle/perpendicularity of the shaft and rotor core in an assembly.

Conventional injection molding techniques resulted in unstable parts that could not pass a thermal shock requirement, had unacceptable visual aesthetics, and had too much dimensional variation. Our solution was to divide the overmolding into 2 steps, introducing the Step 1 material in a designed cross section configuration which resulted in a more even and balanced axial flow pattern of the subsequent Step 2 Overmolding. See Operation Section, below.

### PRIOR ART

A novelty search was completed for an over molded, high-performance motor and actuator rotor with product and process improvements necessary to maintain a critical magnetic air gap. It revealed the following:
A. Euro Patent EP0212552A2 by Brown issued in 1989 for Method for producing a composite sleeve for an electric motor. It is an electric motor having a plurality of magnets bonded to a rotor hub, a composite sleeve is disposed over the rotor hub/magnet assembly. The composite sleeve may be wound directly upon the rotor hub or may be wound upon a mandrel and slid over the rotor hub/magnet assembly.
B. Great Britain Patent GB2117188A by Nashiki et al., issued in 1986 for A permanent magnet rotor for synchronous motors. It is a group of magnets of a permanent magnet rotor that are attached to the rotor shaft using side plates at either end of the magnets, the side plates having grooves for receiving an end of a magnet and being adhered to the shaft. The outer peripheries of the side plates and the magnets are wound with a layer of non-magnetic fibers 5 thereby greatly enhancing the reliability of the motor by effectively preventing axial or circumferential movement of the magnets.
C. US Patent U.S. Pat. No. 8,853,908 by Musselman et al., issued in 2014 for Magnet rotor assembly including a vacuum impregnated bonded magnet having increased crush strength at high temperatures. It shows a magnet rotor assembly comprises a magnet sleeve held on a rotor shaft by a rigid adhesive layer that includes at least one axial wedge shape corresponding to an axial irregularity on at least one of the surfaces bonded by the adhesive layer. Improved crush strength in the magnet sleeve and in other bonded metal parts, both initially and after exposure to high temperatures, is accomplished by impregnating the parts with a curable resin.
D. US Patent U.S. Pat. No. 8,957,669 by Musselman et al., issued in 2015 for Magnet and holder assembly having improved rotational and axial stability. This is a magnet held in a magnet holder is constrained against radial or axial instability, or against both, by a shape on either component in contact with complementary shape on the other component, the shaped components generally defining a tab-and-slot arrangement. The magnet component may be a bonded magnet and in one embodiment may be formed in place by injection molding. The magnet also will exhibit improved magnet properties when magnetized to have lines of polarity matching a path defined by the bulk of the magnetic material as governed by the location of tabs on the magnet. The invention is useful in magnet-sensor assemblies found in industrial applications and in automotive applications such as power steering systems.
E. US Patent U.S. Pat. No. 10,102,953 by Powell et al., issued in 2018 for Apparatus and methods for magnet retention. It Shows an apparatus and method for holding permanent magnet components, particularly on a rotor of an electrical machine. A magnet carrier comprises a channel suitable for receiving an encircling magnet retainer and a method of manufacturing a magnet assembly comprises providing a magnet carrier comprising a channel, mounting a magnet on the magnet carrier, and encircling the magnet and magnet carrier with a magnet retainer, wherein the magnet retainer passes through the channel.
F. US Patent U.S. Pat. No. 11,303,174 by Frohlich et al., issued in 2022 for a Rotor for an electric machine. This is has various embodiments may include a rotor for an electric machine, the rotor comprising: a first shaft journal; a second shaft journal; a laminated rotor core; a filler body cast onto the laminated rotor core wherein the filler body and the laminated rotor core rotate conjointly; and a cooling duct extending through the shaft journals and the filler body along an axis of the filler body and the rotor core. The filler body rotates with the shaft journals and a torque applied to the shaft journals is transmitted to the laminated rotor core.

As can be observed, none of the prior art has anticipated or caused one skilled in rotors and stators with high energy magnets to see this unique product and process improvements with this improved high energy rotor device.

### SUMMARY OF THE INVENTION

The preferred embodiment of the over molded, high-performance motor and actuator rotor 30 with product and process improvements necessary to meet the tight dimensional requirements that are necessary to maintain a critical magnetic air gap when utilized with high energy magnets affixed to the perimeter of the rotor has been described above. It is an improved high energy rotor device 30 comprised of: (a) a powdered metal core with an aperture for a shaft and a predetermined number of flats, each flat with a recess for an adhesive to attach a set of high energy magnets; (b) the predetermined number of high energy magnets assembled onto the flats of the powdered metal core and securely attached to the core recess by the adhesive; (c) the shaft with one end press fitted into the aperture of the core and the other end having a drive pinion gear attached (optional); and (d) a two stage plastic over mold with a first stage adjacent to the flats, adhesive and high energy magnets and the second stage surrounding and encasing the high energy magnets and the core wherein the improved high energy rotor device is manufactured with a set of process improvements including (i) sandblast (or equal) a surface on the core immediately before placing the adhesive to roughen the reservoir surface and to minimize oxidation and contamination; (ii) create a rectangular recess and “reservoir” on each surface of the PM core to reduce inconsistent application of the adhesive between the magnet and the PM core; (iii) configure the shaft with a parallel knurl at one end to press the knurled end into the aperture 49 of the rotor core; and (iv) divide the overmolding into 2 steps, introducing the Step 1 material in a designed cross section configuration which resulted in a more even and balanced axial flow pattern for a subsequent Step 2 Overmolding whereby the process improvements enable the high energy rotor device to meet a series of tight dimensional requirements which are necessary to maintain a critical magnetic air gap in motors and actuators when utilized with high energy magnets that are affixed to the perimeter of the rotor.

### Objects and Advantages

There are several objects and advantages of the over molded, high-performance motor and actuator rotor. These advantages and benefits can help the performance, manufacturing, quality, and repeatability of high energy rotors and hence motors and actuator as well. These are discussed in the Operation Section, below. Other advantages and additional features of the present over molded, high-performance motor and actuator rotor will be more apparent from the accompanying drawings and from the full description of the device. For one skilled in the art of innovative and high energy rotors for motors and actuators, it is readily understood that the features shown in the examples with this product can be adapted to other types of high energy devices and accessories.

### DESCRIPTION OF THE DRAWINGS—FIGURES

The accompanying drawings, which are incorporated in and constitute a part of this specification, illustrate an embodiment of an over molded, high-performance motor and actuator rotor. The drawings together with the summary description given above and a detailed description given below help to explain the principles of the over molded, high-performance motor and actuator rotor device. It is understood, however, that this device is not limited to only the precise arrangements and instrumentalities shown.

FIGS. 1 A through 1 D are sketches portraying an overview of an over molded, high-performance motor and actuator rotor 30 with certain components and process steps noted.

FIGS. 2 A through 2 I are sketches of the powder metal core and over molded rotor 30 with components and features noted.

FIG. 3 with Section “A”, Section “B” and Section “C” are sketches of the tight dimensions held for the powder metal core, assembled core, and knurled shaft of the motor and actuator rotor with components and features noted. These permit a critical gap between the rotor and stator once assembled to be achieved. FIGS. 3 A, 3 B, and 3 C show optional core types for the rotor core.

FIGS. 4 A through 4 D are sketches of the processes necessary to hold the tight tolerances for the air gap needed.

FIGS. 5 A through 5 F are sketches of the sub assembly of the motor and actuator rotor with the components and features noted.

FIGS. 6 A through 6 D are sketches of the over molding details for the motor and actuator rotor with the components and features noted.

FIGS. 7 A through 7 D are sketches of the test findings for the over mold prototypes of the motor and actuator rotor.

FIG. 8 A through 8 F are sketches of product and process concepts and details used with prior art.

### DESCRIPTION OF THE DRAWINGS—REFERENCE NUMERALS

The following list refers to the drawings:

TABLE B
Reference numbers -

| | |
|---|---|
| 30 | an over molded, high-performance motor and |
| | actuator rotor 30 with product and process |
| | improvements necessary to meet the tight |
| | dimensional requirements that are necessary to |
| | maintain a critical magnetic air gap when utilized |
| | with high energy magnets affixed to the perimeter |
| | of the rotor |
| 34 | sub assembly rotor core 34 prior to exterior |
| | surface 51 over mold plastic 75 |
| 35 | rotor core 35 after exterior surface 51 over |
| | molded with plastic 75 |
| 36 | layout 36 showing mechanical dimensions for rotor |
| | core 40 |
| 37 | layout 37 showing mechanical dimensions for rotor |
| | core 40 and shaft 55 engagement |
| 40 | powdered metal rotor core 40 such as a low carbon, |
| | mostly iron, powdered metal, known as Grade F-0000-15 |
| | or equal [MPIF Standard 35 F-0000 Iron Fe Powder |
| | Metallurgy Self-Lubricated Bearing and Component] |
| 40A | wrought iron rotor core 40A with features and |
| | places for magnet placement like the powder metal |
| | core 40 |
| 40B | steel lamination rotor core 40C with steel lams |
| | configured dimensioned thin (such as 8 MM) to |
| | eliminate/reduce eddy currents |
| 40C | weld 40C for steel lam stack 40B |
| 40D | tab 40D for securing magnets 50 |
| 41 | formed corners 41 of powdered and wrought metal |
| | rotor core 40, 40A |
| 46 | flat area 46 for the magnets 50 of the over molded, |
| | high-performance motor and actuator rotor 30 |
| 46A | aperture 46 for the magnets 50 of the steel lam |
| | stack 40B core |
| 49 | aperture, opening 49 for shaft 55 with a straight |
| | knurl 56 to be pressed and assembled into a |
| | powdered metal rotor core 40, wrought core 40 A |
| | and steel lamination core 40B at the end opposite |
| | the drive end (with optional pinion 59) |
| 50 | high energy magnets 50 such as ferrite, bonded |
| | ferrite, bonded rare earth, sintered rare earth, |
| | and samarium cobalt or equal (multiple pairs of |
| | north south high energy magnets - 2, 4, 6, 8 etc.) |
| 51 | exterior surface 51 of magnets |
| 53 | gap/recess/reservoir 53 on the flat area 46 for |
| | adhesive 72 to attach the magnets 50 to the rotor |
| | core 40 at the flats 46 |
| 55 | shaft 55 for over molded rotor 30 |
| 56 | straight knurl 56 in the end of the shaft 55 and |
| | for assembling the shaft 55 into the aperture 49 |
| | of the powder metal rotor core 40 |
| 56A | configuration 56A of a straight or parallel knurl |
| 56B | Exploded view 56B of parallel teeth of knurl |
| 57 | corner gaps 57 between the rotor core corners 41 |
| | and the high energy magnets 50 |
| 59 | drive pinion, spur gear 59 (optional) on shaft 55 |
| | of rotor 30 |
| 70 | stage 1 initial over mold plastic 70 around |
| | magnets 50 at the flats 46 of the rotor core 40 |
| | with PPS Plastic - Polyphenylene sulfide. (PPS |
| | material is a semi crystalline, thermoplastic high |
| | temperature polymer and chemically known as |
| | polyphenylene sulfide; due to its structure, PPS |
| | plastic is chemical and corrosion resistant and |
| | has particularly good mechanical strength) |
| 72 | adhesive 72 glue, bonding agent, cement to attach |
| | the magnets 50 to the rotor core 40 at the flats |
| | 46 such as Loctite with heat and water resistance |
| 75 | exterior surface (approximately 0.5 mm thick) over |
| | mold plastic 75 over high energy magnets 50 and |
| | exterior surface 51 of magnets 50 with PPS Plastic - |
| | Polyphenylene sulfide. (PPS material is a semi |
| | crystalline, thermoplastic high temperature |
| | polymer and chemically known as polyphenylene |
| | sulfide; due to its structure, PPS plastic is |
| | chemical and corrosion resistant and has |
| | particularly good mechanical strength |
| 77 | sprues/gates 77 for exterior plastic over mold 75 |
| | of rotor core 35 |
| 80 | sandblast or equal equipment 80 for rotor 40 to |
| | roughen and preclean the gap/recess/reservoir 53 |
| 82 | holding shaft 82 for loading multiple rotor cores |
| | 40 for sandblast 80 |
| 83 | fixture 83 for holding multiple holding shafts 82 |
| | for sandblast 80 |
| 84 | multiple sections 84 for removably securing and |
| | holding shafts 82 with rotor cores 40 onto fixture 83 |
| 85 | handle 85 for fixture 83 |
| 87 | blow-off and cleaning equipment 87 for rotor core |
| | 40 after sand blast machine 80 |
| 88 | customer equipment 88 installing rotor core 35 |
| | into customer assembly |
| 90 | Sketch of a prototype test units 90 of rotor cores 35 |
| 91 | tracking number 91 for prototype test units 90 |
| 92 | reject indicators 92 cracks, pops, separation of |
| | plastic 75 from rotor core 35 |
| 700 | Prior Art 700 Euro Pat EP0212552A2 Issued in 1987 |
| | to Brown for a Method for producing a composite |
| | sleeve for an electric motor |
| 710 | Prior Art 710 GB Pat 2117188A Issued in 1990 to |
| | Stokley for a permanent magnet rotor for |
| | synchronous motors. |
| 720 | Prior Art 720 U.S. Pat No. 11,303,174 Issued in 2022 |
| | to Frohlich et al. for a Rotor for an electric machine |
| 730 | Prior Art 730 U.S. Pat No. 6,452,301 2002 by Dine |
| | et al for a Magnet retention arrangement for high- |
| | speed rotors |
| 740 | Prior Art 740 U.S. Pat No. 8,957,669 A1 Issued in 2015 |
| | by Musselman et al for a Magnet and holder assembly |
| | having improved rotational and axial stability |
| 750 | Prior Art 750 U.S. Pat No. 8,853,908 Issued in 2014 |
| | by Musselman et al for a Magnet rotor assembly |
| | including a vacuum impregnated bonded magnet having |
| | increased crush strength at high temperatures |

### DETAILED DESCRIPTION OF PREFERRED EMBODIMENT

This invention relates to an over molded, high-performance motor and actuator rotor with product and process improvements necessary to maintain a critical magnetic air gap when utilized with high energy magnets affixed to the perimeter of the rotor.

There are several objects and advantages of the over-molded, high-performance motor and actuator rotor. These advantages and benefits can help the performance, manufacturing, quality, and repeatability of high energy rotors and hence motors and actuator as well. These are discussed in the Operation Section, below.

The preferred embodiment of the over molded, high-performance motor and actuator rotor 30 with product and process improvements necessary to meet the tight dimensional requirements that are necessary to maintain a critical magnetic air gap when utilized with high energy magnets affixed to the perimeter of the rotor has been described above. It is an improved high energy rotor device 30 comprised of: (a) a powdered metal core with an aperture for a shaft and a predetermined number of flats, each flat with a recess for an adhesive to attach a set of high energy magnets; (b) the predetermined number of high energy magnets assembled onto the flats of the powdered metal core and securely attached to the core recess by the adhesive; (c) the shaft with one end press fitted into the aperture of the core and the other end having a drive pinion gear attached (optional); and (d) a two stage plastic over mold with a first stage adjacent to the flats, adhesive and high energy magnets and the second stage surrounding and encasing the high energy magnets and the core wherein the improved high energy rotor device is manufactured with a set of process improvements including (i) sandblast (or equal) a surface on the core immediately before placing the adhesive to roughen the reservoir surface and to minimize oxidation and contamination; (ii) create a rectangular recess and “reservoir” on each surface of the PM core to reduce inconsistent application of the adhesive between the magnet and the PM core; (iii) configure the shaft 55 with a parallel knurl 56 at one end to press the knurled end 56 into the aperture 49 of the rotor core 40; and (iv) divide the overmolding into 2 steps, introducing the Step 1 material in a designed cross section configuration which resulted in a more even and balanced axial flow pattern for a subsequent Step 2 Overmolding whereby the process improvements enable the high energy rotor device to meet a series of tight dimensional requirements which are necessary to maintain a critical magnetic air gap in motors and actuators when utilized with high energy magnets that are affixed to the perimeter of the rotor.

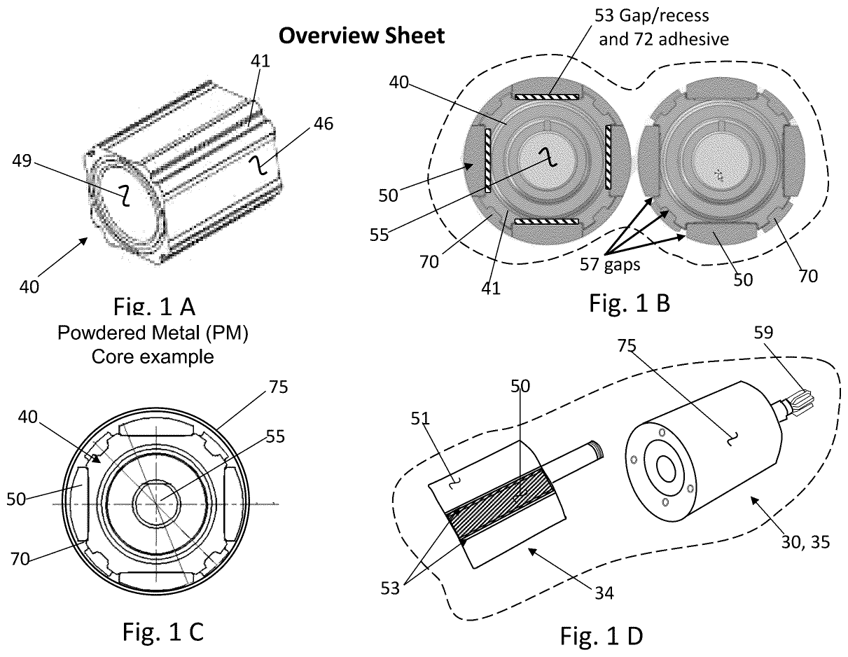

There is shown in FIGS. 1-8 a complete description and operative embodiment of an over molded, high-performance motor and actuator rotor 30 with product and process improvements necessary to meet the tight dimensional requirements that are necessary to maintain a critical magnetic air gap when utilized with high energy magnets affixed to the perimeter of the rotor. In the drawings and illustrations, one notes well that FIGS. 1-8 demonstrate the general configuration and use of this rotor component made with specific processes. The operation and use section below describe how it is manufactured and prepared for the motors or actuators of customers. The accompanying drawings, which are incorporated in and constitute a part of this specification, illustrate an embodiment of the over molded, high-performance motor and actuator rotor 30 with necessary product and process improvements and utilized with high energy magnets affixed to the perimeter of the rotor 30. The drawings together with the summary description given above and a detailed description given below explain the principles of the over molded, high-performance motor and actuator rotor 30. It is understood, however, that device 30 is not limited to only the precise arrangements and instrumentalities shown. Other examples for using the device and their potential uses are still understood by one skilled in the art of rotor design and manufacturing when using high energy magnets and associated processes to be within the scope and spirit shown here for this special rotor.

FIGS. 1 A through 1 D are sketches portraying an overview of an over molded, high-performance motor and actuator rotor 30 with certain components and process steps noted. Presented here in the overview include: an over molded, high-performance motor and actuator rotor 30 with product and process improvements necessary to meet the tight dimensional requirements that are necessary to maintain a critical magnetic air gap when utilized with high energy magnets affixed to the perimeter of the rotor; a sub assembly rotor core 34 prior to exterior surface 51 over mold plastic 75; a rotor core 35 after exterior surface 51 over molded with plastic 75; a powdered metal rotor core 40; a set of formed corners 41 of powdered metal rotor core 40; a number of flat area 46 for the magnets 50 of the over molded, high-performance motor and actuator rotor 30; an aperture, opening 49 for shaft 55 in powdered metal rotor core 40; a high energy magnets 50 such as ferrite, bonded ferrite, bonded rare earth, sintered rare earth, and samarium cobalt or equal (multiple pairs of north south high energy magnets—2, 4, 6, 8 etc.); an exterior surface 51 of magnets; a set of gap/recess/reservoir 53 on the flat area 46 for adhesive 72 to attach the magnets 50 to the rotor core 40 at the flats 46 such as Locktite® with heat and water resistance; a shaft 55 for over molded rotor 30; a set of corner gaps 57 between the rotor core corners 41 and the high energy magnets 50; a drive pinion, spline or spur gear 59 (optional) on one end shaft 55 of rotor 30; a stage 1 initial over mold plastic 70 around magnets 50 at the flats 46 of the rotor core 40 with PPS Plastic-Polyphenylene sulfide. (PPS material is a semi crystalline, thermoplastic high temperature polymer and chemically known as polyphenylene sulfide; due to its structure, PPS plastic is chemical and corrosion resistant and has very good mechanical strength); an adhesive 72 glue, bonding agent, cement to attach the magnets 50 to the rotor core 40 at the flats 46; and an exterior surface (approximately 0.5 mm thick) over mold plastic 75 over high energy magnets 50 and exterior surface 51 of magnets 50 also with PPS Plastic-Polyphenylene sulfide. (PPS material is a semi crystalline, thermoplastic high temperature polymer and chemically known as polyphenylene sulfide; due to its structure, PPS plastic is chemical and corrosion resistant and has particularly good mechanical strength.

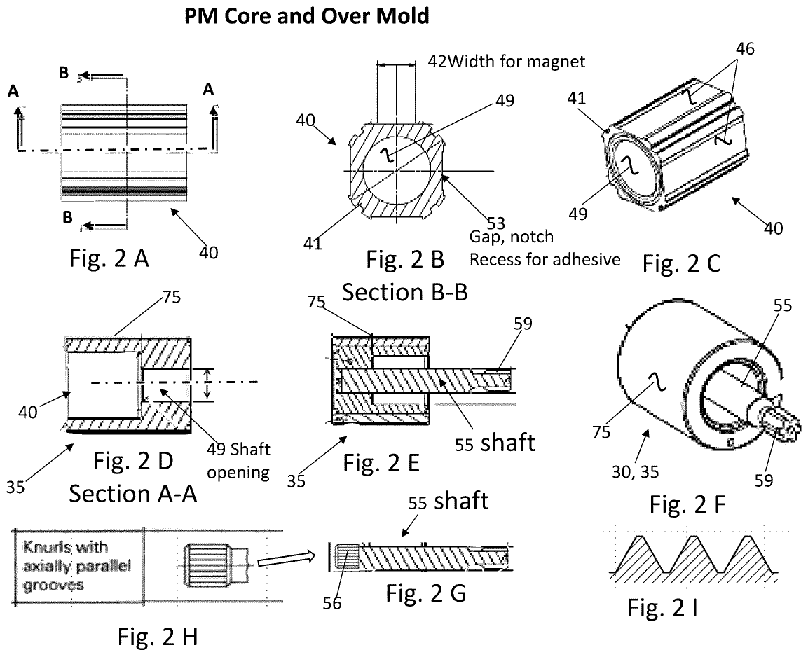

FIGS. 2 A through 2 I are sketches of the powder metal core and over molded rotor 30 with components and features noted. Portrayed in these sketches are: a rotor core 35 after exterior surface 51 over molded with plastic 75; a powdered metal rotor core 40 such as a low carbon, mostly iron, powdered metal, known as Grade F-0000-15 or equal [MPIE Standard 35 F-0000 Iron Fe Powder Metallurgy Self-Lubricated Bearing and Component]; a set of formed corners 41 of powdered metal rotor core 40; a number of flat area 46 for the magnets 50 of the over molded, high-performance motor and actuator rotor 30; an aperture, opening 49 for shaft 55 with a straight knurl 56 to be pressed and assembled into a powdered metal rotor core 40 at the end opposite the drive end (with optional pinion 59); a set of gap/recess 53 on the flat area 46 for adhesive 72 to attach the magnets 50 to the rotor core 40 at the flats 46 such as Loctite® with heat and water resistance; a shaft 55 for over molded rotor 30; a straight knurl 56 in the end of the shaft 55 which permits assembling the shaft 55 into the aperture 49 of the powder metal rotor core 40; a configuration 56A of a straight or parallel knurl; an exploded view 56B of parallel teeth of knurl; a drive pinion, spur gear 59 (optional) on one end shaft 55 of rotor 30; and an exterior surface (approximately 0.5 mm thick) over mold plastic 75 over high energy magnets 50 and exterior surface 51 of magnets 50 with PPS Plastic-Polyphenylene sulfide. (PPS material is a semi crystalline, thermoplastic high temperature polymer and chemically known as polyphenylene sulfide. Due to its structure, PPS plastic is chemical and corrosion resistant and has particularly good mechanical strength).

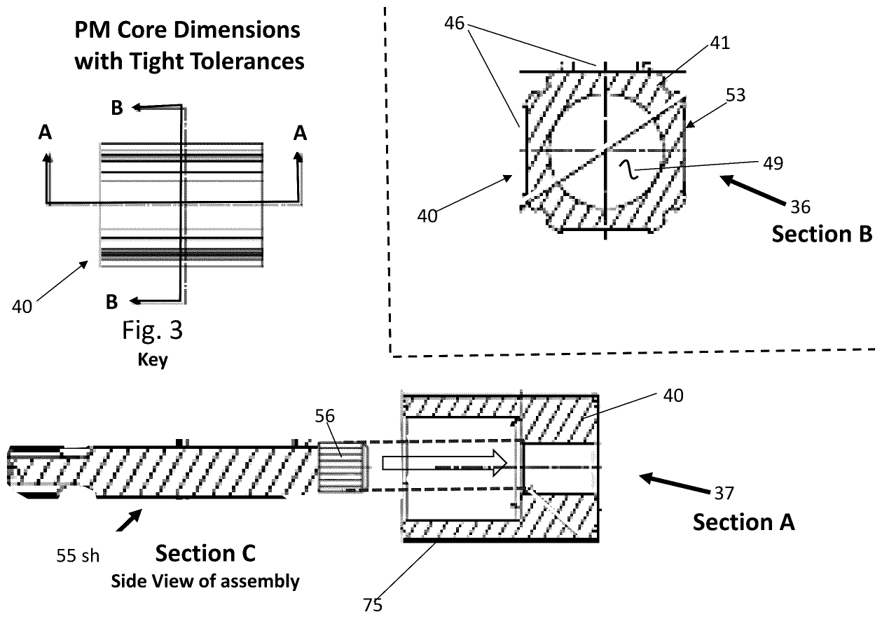

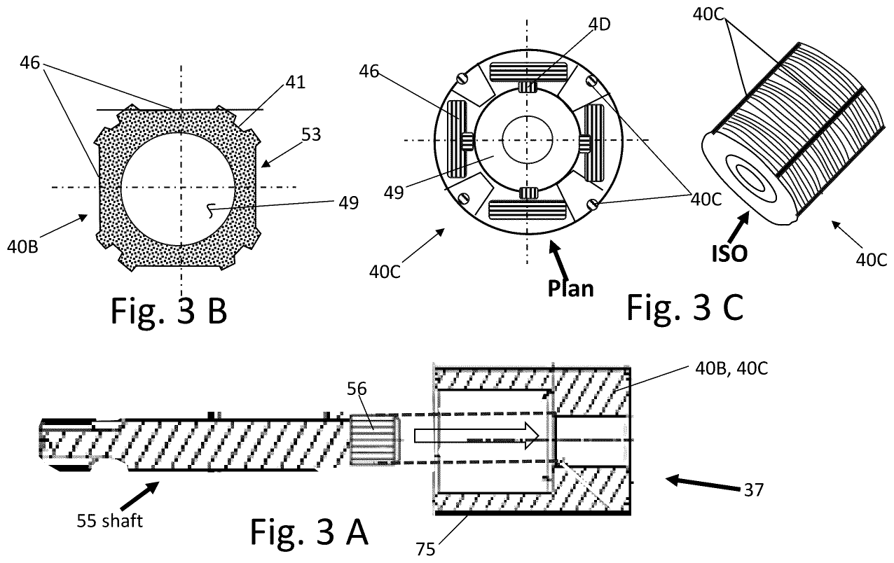

FIG. 3 with “A”, “B” and “C” are sketches of the tight dimensions held for the powder metal core 40 and assembled core 40 and knurled shaft 55 of the motor and actuator rotor with components and features noted. These are required to permit repeatable assembly for maintaining a critical gap between the rotor and stator once assembled to be achieved. The critical gap (of less than 1.0 mm) between the rotor and stator once assembled can be achieved and repeated. Demonstrated here as critical dimensions include a layout 36 showing mechanical dimensions for rotor core 40; a layout 37 showing mechanical dimensions for rotor core 40 and shaft 55 engagement; a powdered metal rotor core 40; a set of formed corners 41 of powdered metal rotor core 40; a number of flat area 46 for the magnets 50 of the over molded, high-performance motor and actuator rotor 30; an aperture, opening 49 for shaft 55 with a straight knurl 56 to be pressed and assembled into a powdered metal rotor core 40 at the end opposite the drive end (with optional pinion 59); a configuration 56A of a straight or parallel knurl; and exploded view 56B of parallel teeth of knurl; and an exterior surface (approximately 0.5 mm thick) over mold plastic 75 over high energy magnets 50 and exterior surface 51 of magnets 50 with PPS Plastic-Polyphenylene sulfide. FIGS. 3 A, 3 B, and 3 C show a couple optional core types for the rotor core. Shown here are the wrought iron rotor core 40A with features and places for magnet placement similar to the powder metal core 40; a steel lamination rotor core 40C with steel lams configured dimensioned thin (such as 8 MM) to eliminate/reduce eddy currents; a weld 40C for steel lam stack 40B, a tab 40D for securing magnets 50, an aperture 46 for the magnets 50 of the steel lam stack 40B core, an aperture, opening 49 for shaft 55 with a straight knurl 56 to be pressed and assembled into a powdered metal rotor core 40, a wrought core 40 A, and/or a steel lamination core 40C at the end opposite the drive end (with optional pinion 59).

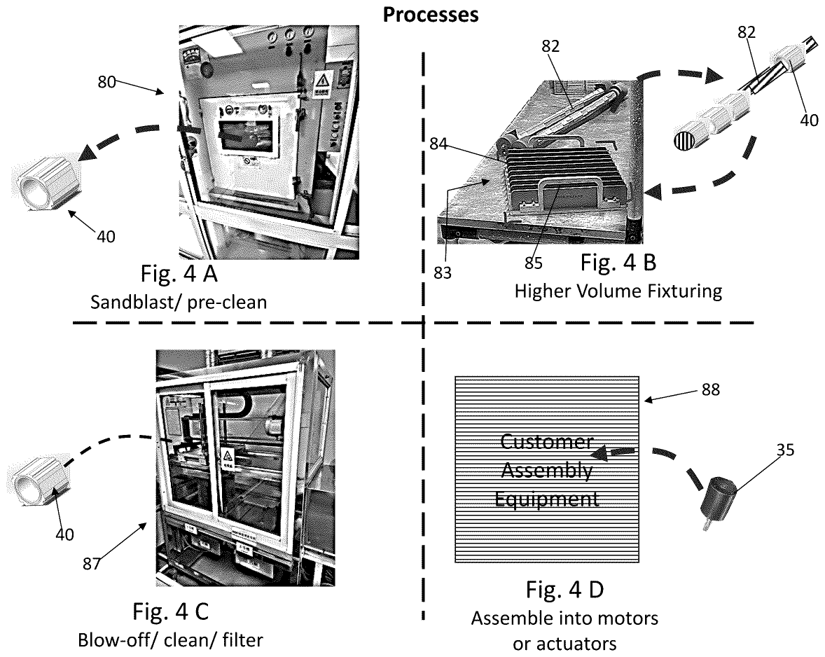

FIGS. 4 A through 4 D are sketches of the processes necessary to hold the tight tolerances for the air gap needed. Shown in these equipment and process sketches are: a rotor core 35 after exterior surface 51 over molded with plastic 75; a powdered metal rotor core 40 such as a low carbon, mostly iron, powdered metal; a sandblast and pre-clean equipment 80 for rotor 40; a holding shaft 82 for loading multiple rotor cores 40 for sandblast 80; a fixture 83 for holding multiple holding shafts 82 for sandblast machine 80; a number of multiple sections 84 for removably securing and holding shafts 82 with rotor cores 40 onto fixture 83; a pair of handles 85 for fixture 83; a blow-off and cleaning equipment 87 for rotor core 40 after sand blast machine 80; and a customer equipment 88 installing rotor core 35 into customer assembly.

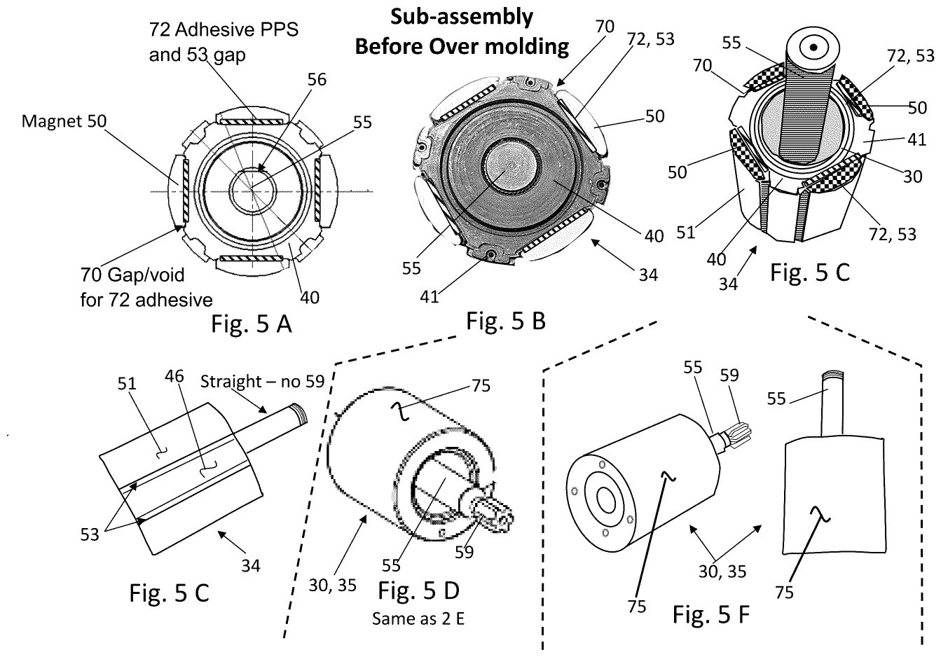

FIGS. 5 A through 5 F are sketches of the sub assembly of the motor and actuator rotor 30 with the components and features noted. Presented in these drawings are: an over molded, high-performance motor and actuator rotor 30 with product and process improvements necessary to meet the tight dimensional requirements that are necessary to maintain a critical magnetic air gap when utilized with high energy magnets affixed to the perimeter of the rotor; a sub assembly rotor core 34 prior to exterior surface 51 over mold plastic 75; a rotor core 35 after exterior surface 51 over molded with plastic 75; a powdered metal rotor core 40; a set of formed corners 41 of powdered metal rotor core 40; a number of flat area 46 for the magnets 50 of the over molded, high-performance motor and actuator rotor 30; a set of high energy magnets 50 such as ferrite, bonded ferrite, bonded rare earth, sintered rare earth, and samarium cobalt or equal (multiple pairs of north south high energy magnets-2, 4, 6, 8 etc.); an exterior surface 51 of magnets 50; a set of gap/recess 53 on the flat area 46 for adhesive 72 to attach the magnets 50 to the rotor core 40 at the flats 46 such as Locktite® with heat and water resistance; a shaft 55 for over molded rotor 30; a drive pinion, spur gear 59 (optional) on one end shaft 55 of rotor 30; a stage 1 initial over mold plastic 70 around magnets 50 at the flats 46 of the rotor core 40 with PPS Plastic-Polyphenylene sulfide; an adhesive 72 glue, bonding agent, cement to attach the magnets 50 to the rotor core 40 at the flats 46; and an exterior surface (approximately 0.5 mm thick) over mold plastic 75 over high energy magnets 50 and exterior surface 51 of magnets 50 also with PPS Plastic-Polyphenylene sulfide.

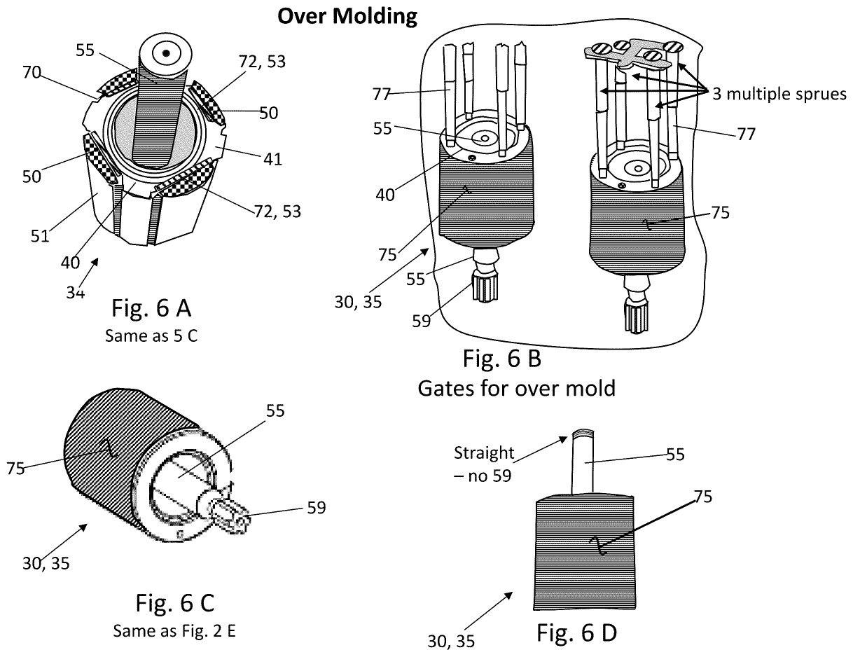

FIGS. 6 A through 6 D are sketches of the over molding details for the motor and actuator rotor 30 with the components and features noted. Noted in these sketches are: an over molded, high-performance motor and actuator rotor 30 with product and process improvements necessary to meet the tight dimensional requirements that are necessary to maintain a critical magnetic air gap when utilized with high energy magnets affixed to the perimeter of the rotor; a sub assembly rotor core 34 prior to exterior surface 51 over mold plastic 75; a rotor core 35 after exterior surface 51 over molded with plastic 75; a powdered metal rotor core 40; a set of high energy magnets 50 such as ferrite, bonded ferrite, bonded rare earth, sintered rare earth, and samarium cobalt or equal (multiple pairs of north south high energy magnets—2, 4, 6, 8 etc.); an exterior surface 51 of magnets; a set of gap/recess 53 on the flat area 46 for adhesive 72 to attach the magnets 50 to the rotor core 40 at the flats 46 such as Locktite® with heat and water resistance; a shaft 55 for over molded rotor 30; a drive pinion, spur gear 59 on one end shaft 55 of rotor 30; a stage 1 initial over mold plastic 70 around magnets 50 at the flats 46 of the rotor core 40 with PPS Plastic-Polyphenylene sulfide; an adhesive 72 glue, bonding agent, cement to attach the magnets 50 to the rotor core 40 at the flats 46; an exterior surface (approximately 0.5 mm thick) over mold plastic 75 over high energy magnets 50 and exterior surface 51 of magnets 50 also with PPS Plastic-Polyphenylene sulfide; and a set of sprues/gates 77 for exterior plastic over mold 75 of rotor core 35.

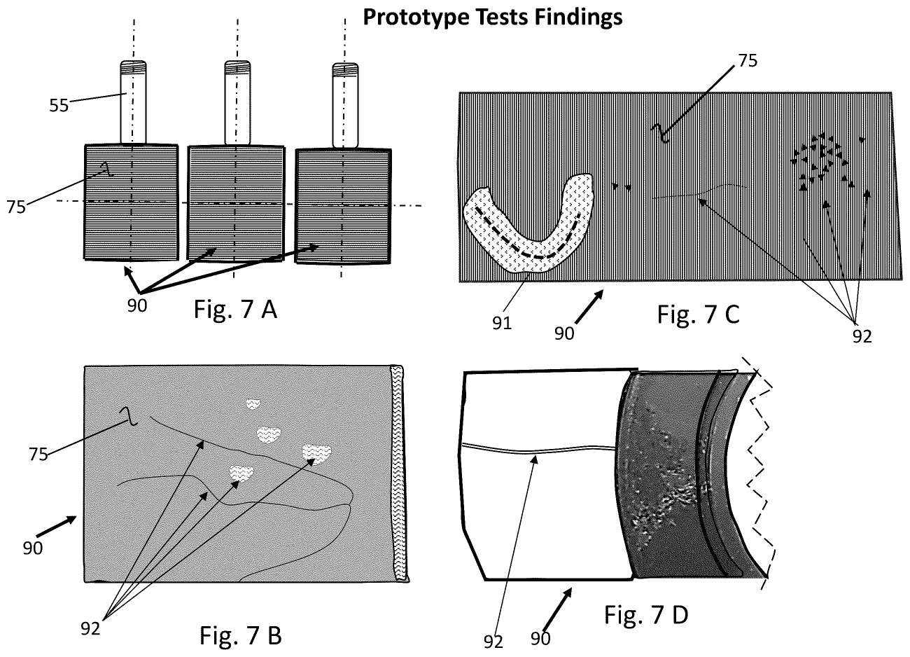

FIGS. 7 A through 7 D are sketches of the test findings for the over mold prototypes 90 of the motor and actuator rotor. Displayed here are: an exterior surface (approximately 0.5 mm thick) over mold plastic 75 over high energy magnets 50 and exterior surface 51 of magnets 50 with PPS Plastic-Polyphenylene sulfide; a group of prototype test units 90 of rotor cores 35; a tracking number or marking 91 for prototype test units 90; and a set of reject indicators 92 cracks, pops, separation of plastic 75 from rotor core 35.

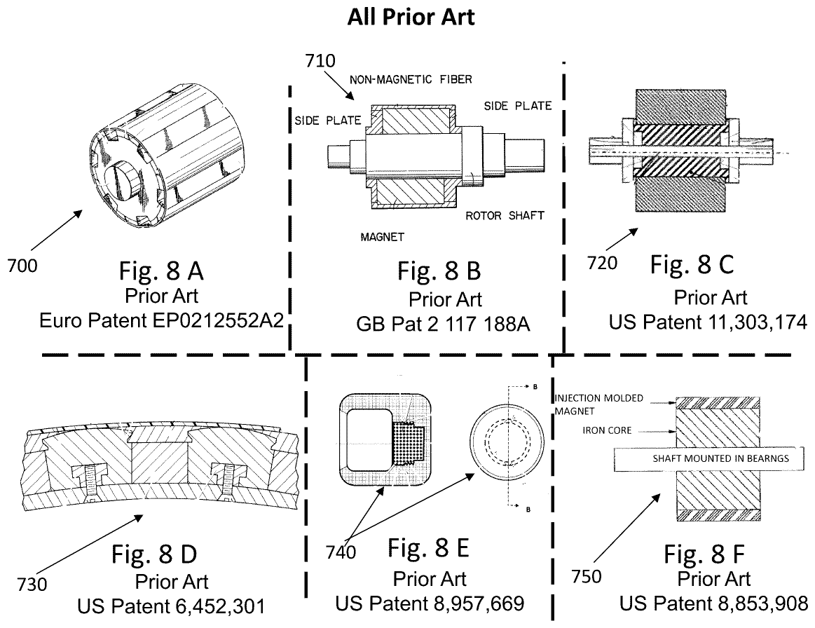

FIG. 8 A through 8 F are sketches of product and process concepts and details used with prior art. These include: a Prior Art 700 Euro Pat EP0212552A2 Issued in 1987 to Brown for a Method for producing a composite sleeve for an electric motor; a Prior Art 710 GB Pat 2117188A Issued in 1990 to Stokley for a permanent magnet rotor for synchronous motors; a Prior Art 720 US Pat 11, 303, 174 Issued in 2022 to Frohlich et al. for a Rotor for an electric machine; a Prior Art 730 U.S. Pat. No. 6,452,301 2002 by Dine et al for a Magnet retention arrangement for high speed rotors; a Prior Art 740 U.S. Pat. No. 8,957,669 A1 Issued in 2015 by Musselman et al for a Magnet and holder assembly having improved rotational and axial stability; and a Prior Art 750 US Patent 8, 853, 908 Issued in 2014 by Musselman et al for a Magnet rotor assembly including a vacuum impregnated bonded magnet having increased crush strength at high temperatures. As can be seen, the over molded, high-performance motor and actuator rotor 30 with product and process improvements necessary to meet the tight dimensional requirements that are necessary to maintain a critical magnetic air gap when utilized with high energy magnets affixed to the perimeter of the rotor core 40 is a unique motor and/or actuator rotor device 30 with the advantages shown above.

The materials, components, and processes shown above for the over molded, high-performance motor and actuator rotor 30 with product and process improvements necessary to meet the tight dimensional requirements (less than 0.3 mm) that are required to maintain a critical magnetic air gap (of less than 1.0 mm) when utilized with high energy magnets affixed to the perimeter of the rotor. These anticipated materials, for example and not limitation, include: powdered metal rotor core 40 such as a low carbon, mostly iron, powdered metal, known as Grade F-0000-15 or equal [MPIF Standard 35 F-0000 Iron Fe Powder Metallurgy Self-Lubricated Bearing and Component]; high energy magnets 50 such as ferrite, bonded ferrite, bonded rare earth, sintered rare earth, and samarium cobalt or equal (multiple pairs of north south high energy magnets—2, 4, 6, 8 etc.); PPS Plastic-Polyphenylene sulfide. (PPS material is a semi crystalline, thermoplastic high temperature polymer and chemically known as polyphenylene sulfide; due to its structure, PPS plastic is chemical and corrosion resistant and has very good mechanical strength); and adhesive 72 glue, bonding agent, cement to attach the magnets 50 to the rotor core 40 at the flats 46 such as Loctite with heat and water resistance.

The details mentioned here are exemplary and not limiting. Other specific components and manners specific to describing an over molded, high-performance motor and actuator rotor 30 with product and process improvements necessary to meet the tight dimensional requirements that are necessary to maintain a critical magnetic air gap when utilized with high energy magnets affixed to the perimeter of the rotor can be added as a person having ordinary skill in the field of the art of rotors for motors and actuators using high energy magnets for components with the device.

### Operation of the Preferred Embodiment

The preferred embodiment of the over molded, high-performance motor and actuator rotor 30 with product and process improvements necessary to meet the tight dimensional requirements that are necessary to maintain a critical magnetic air gap when utilized with high energy magnets affixed to the perimeter of the rotor has been described above. It is an improved high energy rotor device 30 comprised of: (a) a powdered metal core with an aperture for a shaft and a predetermined number of flats, each flat with a recess for an adhesive to attach a set of high energy magnets; (b) the predetermined number of high energy magnets assembled onto the flats of the powdered metal core and securely attached to the core recess by the adhesive; (c) the shaft with one end press fitted into the aperture of the core and the other end having a drive pinion gear attached (optional); and (d) a two stage plastic over mold with a first stage adjacent to the flats, adhesive and high energy magnets and the second stage surrounding and encasing the high energy magnets and the core wherein the improved high energy rotor device is manufactured with a set of process improvements including (i) sandblast (or equal) a surface on the core immediately before placing the adhesive to roughen the reservoir surface and to minimize oxidation and contamination; (ii) create a rectangular recess and “reservoir” on each surface of the PM core to reduce inconsistent application of the adhesive between the magnet and the PM core; (iii) configure the shaft 55 with a parallel knurl 56 at one end to press the knurled end 56 into the aperture 49 of the rotor core 40; and (iv) divide the overmolding into 2 steps, introducing the Step 1 material in a designed cross section configuration which resulted in a more even and balanced axial flow pattern for a subsequent Step 2 Overmolding whereby the process improvements enable the high energy rotor device to meet a series of tight dimensional requirements which are necessary to maintain a critical magnetic air gap in motors and actuators when utilized with high energy magnets that are affixed to the perimeter of the rotor.

### Problems Addressed and the Operational/Process Solution

The forces on the rotating magnets are significant, and the surface preparations of the core for such applications have been found to require more than normal surface preparation. Powdered Metals (PM) or other soft magnetic metals are commonly used as the materials to make cores in the magnetic circuit of a rotor. Even the thinnest layer of oxidation, or contamination from handling, or contamination from the atmosphere, are all known to produce a surface layer which becomes a barrier to both adhesive strength and to magnetic flux permeability. The solution for this was to sandblast (or equal) the surfaces which will have adhesive applied, and to incorporate this sandblasting step to roughen and clean the reservoir and to happen in the processing step just prior to adhesive application, connected and operated simultaneously so that the adhesive and magnets are applied to the fresh/rough surface of the core and cured without delay.

An inconsistent application of the adhesive between the magnet and the PM core will contribute to unacceptable variation in the outer profile of the rotor and correspondingly cause severe variation in the airgap of the assembled system. The solution was to design and create a rectangular volume or “well” or “reservoir” on each surface of the PM core in the area where the magnets will be affixed. A precisely controlled amount of adhesive is deposited into this well. After curing the adhesive, the resulting variation in the outer profile of the rotor met the tight tolerances required for this motor design. Any layer of wrapping or roving or plastic that is placed over the outer cylindrical surface of the magnets, core, & shaft sub assembly is impinging and reducing the space available for the important magnetic airgap. Yet additional means of retaining the magnets to the core are necessary in addition to the bond strength of the adhesive. The requirements of this design included a very thin overmolding (0.5 mm) of plastic to retain the magnets and also to protect the magnets for corrosion.

Conventional injection molding techniques resulted in unstable parts that could not pass a thermal shock requirement, had unacceptable visual aesthetics, and had too much dimensional variation. Our solution was to divide the overmolding into 2 steps, introducing the Step 1 material in a designed cross section configuration which resulted in a more even and balanced axial flow pattern of the subsequent Step 2 Overmolding. This change from 1 Step to 2 Step molding, and the specifically designed profile and method & our Step 1, resulted in less severe dimensional variation, and met the part & assembly requirements that the 1 step method could not obtain.

The configuration of the shaft and core can impact the dimensional integrity and angular relationship of the mounting shaft 55 and the rotor core 40. A press fit between a shaft 55 and a rotor core 40 can only hold so much resistance force for radial and axial movement between the shaft and the core. The integrity of the shaft and core is much improved by featuring a straight/parallel to the axis knurl on the end of the shaft. This knurl in turn allowed the gap between the exterior surface (approximately 0.5 mm thick) over mold plastic 75 over high energy magnets 50 and exterior surface 51 of magnets 50 rotor surface 75 and the stator to have a smaller variation and provided repeatable results. In addition, the knurl 56 increased the rotational resistance and maintained the angle/perpendicularity of the shaft 55 and rotor core 40 (aperture 49) in an assembly. The axial knurl is shown in FIGS. 2 G, 2 H and 2 I. Plus, the assembling of a shaft 55 into the rotor core 40 is demonstrated in FIG. 3 C. The result of holding and maintaining the concentricity of the shaft exterior surface and the interior surface of the aperture in the rotor core. This improves the perpendicularity of the rotor core 40 and shaft 55 and allows for the over mold rotor to be held with a very tight and controlled outer diameter. The tighter dimensions held on the rotor outer diameter means the rotor is manufactured in a repeatable manner. This repeatability then allows for a smaller gap between the rotor and stator. The reduction of the gap between the stator and rotor also directly impacts the power available through the stator in the motor or actuator.

Applications and uses for the over molded, high-performance motor and actuator rotor 30 with product and process improvements necessary to meet the tight dimensional requirements and hold for critical air gaps are still being developed. However, current uses anticipated include EV or Hybrid vehicles.

With this description it is to be understood that the over molded, high-performance motor and actuator rotor 30 with product and process improvements is not to be limited to only the disclosed embodiment of product. The features of the present improved rotor device 30 are intended to cover various modifications and equivalent arrangements included within the spirit and scope of the description shown herein.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of a presently preferred embodiment of this invention. It is also contemplated that various combinations or sub-combinations of the specific features and aspects of the embodiments may be made and still fall within the scope of the inventions. Various features and aspects of the disclosed embodiments can be combined with or substituted for one another to form varying modes of the disclosed inventions. Thus, it is intended that the scope of at least some of the present inventions herein disclosed should not be limited by the disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted as coextensive with any embodiment, feature, or combination of features shown herein. This is true even if only a single embodiment of the feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed considering the number of recited significant digits and by applying ordinary rounding techniques.

The present invention contemplates modifications as would occur to those skilled in the art. While the disclosure has been illustrated and described in detail in the figures and the foregoing description, the same is to be considered as illustrative and not restrictive in character, it being understood that only selected embodiments have been shown and described and that all changes, modifications and equivalents that come within the spirit of the disclosures described heretofore and or/defined by the following claims are desired to be protected.

What is claimed is:

1. An improved high energy rotor device (30) comprised of:
(a) a powdered metal (PM) core (40) with an aperture (49) for a shaft (55) and a predetermined number of flats (46), each flat (46) with a gap/recess/reservoir (53) for an adhesive (72) to attach a set of high energy magnets (50);
(b) the predetermined number [2, 4, 6, 8] of high energy magnets (50) assembled onto the flats (46) of the powdered metal PM core (40) and securely attached to the core recess by the adhesive (72);
(c) the shaft with one end press fitted into the aperture (49) of the PM core (40) and the other end having a drive pinion gear (optional) attached; and
(d) a two-stage plastic (70) over mold with a first stage adjacent to the flats (46), adhesive (72), and high energy magnets (50) and the second stage surrounding and encasing the high energy magnets (50) and the PM core (40);
wherein the improved high energy rotor device (30) is manufactured with a set of process improvements including
(i) roughen and clean (sandblasted) a recess (53) surface on the PM core (40);
(ii) create a rectangular gap/recess/reservoir (53) on each surface of the PM core (40); and
(iii) divide the overmolding into 2 steps
whereby the process improvements enable the high energy rotor (30) device to meet a series of tight dimensional requirements which are necessary to maintain a critical magnetic air gap in motors and actuators when utilized with the high energy magnets (50) that are affixed/glued to the perimeter of the rotor (30).

2. An improved high energy rotor device (30) as described in claim 1 wherein the metal (PM) core (40) is selected from the group consisting of a low carbon, mostly iron, powdered metal, known as Grade F-0000-15 and a MPIF Standard 35 F-0000 Iron Fe Powder.

3. An improved high energy rotor device (30) as described in claim 1, wherein the adhesive (72) is selected from the group consisting of glue, bonding agent, cement, and Locktite® with heat and water resistance.

4. An improved high energy rotor device (30) as described in claim 1 wherein the set of high energy magnets (50) is selected from the group consisting of ferrite, bonded ferrite, bonded rare earth, sintered rare earth, and samarium cobalt.

5. An improved high energy rotor device (30) as described in claim 1 wherein the predetermined number of high energy magnets (50) assembled onto the flats (46) of the powdered metal PM core (40) is selected from the group consisting of 2, 4, 6, and 8.

6. An improved high energy rotor device (30) as described in claim 1 wherein the two-stage plastic (70) over mold with a first stage adjacent to the flats (46) is selected from the group consisting of Plastic-Polyphenylene sulfide (PPS).

7. An improved high energy rotor device (30) as described in claim 1 wherein the metal (PM) core (40) is replaced by a steel lamination rotor core (40C) with steel lams configured dimensioned thin at approximately 8 MM thick to eliminate/reduce eddy currents.

8. An improved high energy rotor device (30) as described in claim 1, wherein the metal (PM) core (40) is replaced by a wrought iron rotor core (40A).

9. An improved high energy rotor device (30) as described in claim 1 wherein a straight knurl (56) is placed at an end of the shaft (55) for assembling the shaft (55) into the aperture (49) of the powder metal rotor core (40).

10. An improved high energy rotor device (30) comprised of:
(a) a powdered metal (PM) core (40) with an aperture (49) for a shaft (55) and a predetermined number of flats (46), each flat (46) with a gap/recess/reservoir (53) for an adhesive (72) to attach a set of high energy magnets (50);
(b) the predetermined number of high energy magnets (50) assembled onto the flats (46) of the powdered metal PM core (40) and securely attached to the core recess by the adhesive (72);
(c) the shaft with one end press fitted into the aperture (49) of the PM core (40) and the other end having a drive pinion gear attached; and
(d) a two-stage plastic (70) over mold with a first stage adjacent to the flats (46), adhesive (72), and high energy magnets (50) and the second stage surrounding and encasing the high energy magnets (50) and the PM core (40);
wherein the improved high energy rotor device (30) is manufactured with a set of process improvements including
(i) roughen and clean (sandblasted) a recess (53) surface on the PM core (40) immediately before placing the adhesive (72) to roughen and clean the reservoir (53) surface and to minimize oxidation and contamination;
(ii) create a rectangular gap/recess/reservoir (53) on each surface of the PM core (40) to reduce inconsistent application of the adhesive (72) between the magnet (50) and the PM core (40); and
(iii) divide the overmolding into 2 steps, introducing the Step 1 material in a designed cross section configuration which resulted in a more even and balanced axial flow pattern for a subsequent Step 2 Overmolding
whereby the process improvements enable the high energy rotor (30) device to meet a series of tight dimensional requirements which are necessary to maintain a critical magnetic air gap in motors and actuators when utilized with the high energy magnets (50) that are affixed/glued to the perimeter of the rotor (30).

11. An improved high energy rotor device (30) as described in claim 10 wherein the metal (PM) core (40) is selected from the group consisting of a low carbon, mostly iron, powdered metal, known as Grade F-0000-15 and a MPIF Standard 35 F-0000 Iron Fe Powder.

12. An improved high energy rotor device (30) as described in claim 10 wherein the adhesive (72) is selected from the group consisting of glue, bonding agent, cement, and Locktite® with heat and water resistance.

13. An improved high energy rotor device (30) as described in claim 10 wherein the set of high energy magnets (50) is selected from the group consisting of ferrite, bonded ferrite, bonded rare earth, sintered rare earth, and samarium cobalt.

14. An improved high energy rotor device (30) as described in claim 10 wherein the predetermined number of high energy magnets (50) assembled onto the flats (46) of the powdered metal PM core (40) is selected from the group consisting of 2, 4, 6, and 8.

15. An improved high energy rotor device (30) as described in claim 10 wherein the two-stage plastic (70) over mold with a first stage adjacent to the flats (46) is selected from the group consisting of Plastic-Polyphenylene sulfide (PPS).

16. An improved high energy rotor device (30) as described in claim 10 wherein the metal (PM) core (40) is replaced by a steel lamination rotor core (40C) with steel lams configured dimensioned thin at approximately 8 MM thick to eliminate/reduce eddy currents.

17. An improved high energy rotor device (30) as described in claim 10 wherein the metal (PM) core (40) is replaced by a wrought iron rotor core (40A).

18. An improved high energy rotor device (30) as described in claim 10 wherein a straight knurl (56) is placed at an end of the shaft (55) for assembling the shaft (55) into the aperture (49) of the powder metal rotor core (40).
